(19) United States
(12) Patent Application Publication
(10) Pub. No.: US 2025/0384278 A1
(43) Pub. Date: Dec. 18, 2025

(54) METHOD AND COMPUTING SYSTEM FOR TRAINING BINARY NEURAL NETWORK MODEL

(71) Applicant: SAMSUNG ELECTRONICS CO., LTD., Suwon-si (KR)

(72) Inventors: Young Sik LEE, Suwon-si (KR); Ju Yeon KANG, Suwon-si (KR); Tae Hee HAN, Seoul (KR); Suk Bong KANG, Osan-si (KR); Chang Ho RYU, Suwon-si (KR)

(73) Assignees: SAMSUNG ELECTRONICS CO., LTD., Suwon-si (KR); RESEARCH & BUSINESS FOUNDATION SUNGKYUNKWAN UNIVERSITY, Suwon-si (KR)

(21) Appl. No.: 19/013,366

(22) Filed: Jan. 8, 2025

(30) Foreign Application Priority Data
Jun. 18, 2024 (KR) 10-2024-0079069

(51) Int. Cl. G06N 3/084; G06N 3/10

(52) U.S. Cl. CPC G06N 3/084; G06N 3/10

(57) ABSTRACT

A method for training a binary neural network (BNN) model includes performing a first training epoch including updating a binary weight of each of layers constituting the binary neural network model using training data; performing a second training epoch including updating the binary weight of each of the layers constituting the binary neural network model; obtaining a sign flip rate of at least one layer among the layers in the second training epoch; determining whether to freeze weight-updating on the at least one layer based on the sign flip rate thereof; and updating a binary weight on a weight-updating unfrozen layer in at least one training epoch performed subsequent to the second training epoch, wherein the weight-updating unfrozen layer excludes at least one weight-updating frozen layer in which the weight-updating is frozen. The second training epoch may be an epoch immediately subsequent to the first training epoch.

### CROSS-REFERENCE TO RELATED APPLICATION

This application claims priority from Korean Patent Application No. 10-2024-0079069 filed on Jun. 18, 2024 in the Korean Intellectual Property Office, and all the benefits accruing therefrom under 35 U.S.C. 119, the disclosures of which are herein incorporated by reference in their entireties.

### BACKGROUND

### 1. Field

One or more example embodiments of the disclosure relate to a method for training a binary neural network model and a computing system for performing the training method.

### 2. Description of Related Art

An inferring model of an artificial neural network structure is widely used. An artificial neural network includes an input layer, a hidden layer including one or more layers, and an output layer, and the layers are sequentially arranged in a direction from the input layer toward the output layer. Furthermore, the artificial neural network has a number of weight between nodes of immediately adjacent layers to each other, and each weight is updated in a training stage. In order to improve inferring performance of the inferring model, a sufficient volume of training data should be provided. A process of performing the training stage using the sufficient volume of training data requires a large amount of computation. Therefore, the training stage requires a lot of computing resources compared to an inferring stage that performs inferring using an inferring model which has been trained.

In general, each of weights that constitute the artificial neural network has a real value. Therefore, many floating point operations need be performed in the inferring stage.

Further, an inferring model with a binary neural network structure with a binary weight has been proposed. The binary neural network model reduces the weight to a data width of 1 bit and thus has great advantages in terms of memory usage and computational speed. In order to compensate for low accuracy of the binary neural network model, various studies such as XNOR-Net and Bi-real have been proposed.

A time required to perform the training stage of the binary neural network model with the binary weight is reduced compared to a time required to perform a training stage of a general artificial neural network with a real number value weight. However, there is a need to further reduce the time and an amount of computing resources required to perform the training stage of the binary neural network model. For example, the training stage may need to be performed in a low-level computing system with limited computing resources.

The inferring model of the artificial neural network structure may be deployed in a low-level computing system such as an edge device rather than a server, and the edge device itself may perform inferring based on artificial intelligence technology for a given situation. Not only the inferring stage may be performed in the low-level computing system, but also the training stage needs be performed in the low-level computing system. Considering this situation, there is a need for a technology that may reduce the amount of computing resources required for performing the training stage on the inferring model of the binary neural network structure.

### SUMMARY

One or more example embodiments of the disclosure provide a method for training a binary neural network model and a computing system for performing the training method.

One or more example embodiments of the disclosure provide a method for deploying a trained binary neural network model to a device and a system for deploying the binary neural network model.

One or more example embodiments of the disclosure provide a method for training a binary neural network model and a computing system for performing the training method, in which an amount of computing resources required for performing a training stage on an inferring model of the binary neural network structure may be reduced while minimizing decrease in inferring performance thereof.

One or more example embodiments of the disclosure provide a method for training a binary neural network model and a computing system for performing the training method, in which early-stopping of training may be adopted to minimize a number of epochs that need be performed in the training stage on the inferring model of the binary neural network structure.

The technical purposes of the disclosure are not limited to the technical purposes as mentioned above, and other technical purposes that are not mentioned may be clearly-understood by those skilled in the art from the descriptions as set forth below.

According to an aspect of an example embodiment of the disclosure, provided is a method for training a binary neural network (BNN) model. The method may be performed by a computing system, and include: performing a first training epoch including updating a binary weight of each of layers constituting the binary neural network model using training data; performing a second training epoch including updating the binary weight of each of the layers constituting the binary neural network model, wherein the second training epoch is an epoch immediately subsequent to the first training epoch; obtaining a sign flip rate of at least one layer among the layers in the second training epoch; determining whether to freeze weight-updating on the at least one layer among the layers based on the sign flip rate of the at least one layer; and updating a binary weight on a weight-updating unfrozen layer in at least one training epoch performed subsequent to the second training epoch, wherein the weight-updating unfrozen layer excludes at least one weight-updating frozen layer in which the weight-updating is frozen.

According to an aspect of an example embodiment of the disclosure, provided is a method for deploying a binary neural network model into a device having a dynamic random access memory (DRAM). The method may include: obtaining parameter information that defines the binary neural network model; and recording the parameter information into the DRAM, wherein the binary neural network model has been pre-generated by performing a training process, and wherein the training process includes: performing a first training epoch for updating a binary weight of each of layers constituting the binary neural network model using training data; performing a second training epoch for updating the binary weight of each of the layers constituting the binary neural network model, wherein the second training epoch is an epoch immediately subsequent to the first training epoch; obtaining a sign flip rate of at least one layer among the layers in the second training epoch; determining whether to freeze weight-updating on the at least one layer among the layers based on the sign flip rate of the at least one layer; and updating a binary weight on a weight-updating unfrozen layer, in at least one training epoch performed subsequent to the second training epoch, wherein the weight-updating unfrozen layer excludes at least one weight-updating frozen layer in which the weight-updating is frozen.

According to an aspect of an example embodiment of the disclosure, provided is a computing system for training a binary neural network model, the computing system including: a memory configured to load therein parameter information defining the binary neural network model and a program for training the binary neural network model and at least one processor configured to execute the program loaded in the memory. The program may include instructions for performing a first training epoch for updating a binary weight of each of layers constituting the binary neural network model using training data, instructions for performing a second training epoch for updating the binary weight of each of the layers constituting the binary neural network model, wherein the second training epoch is an epoch immediately subsequent to the first training epoch; instructions for obtaining a sign flip rate of at least one layer among the layers in the second training epoch; instructions for determining whether to freeze weight-updating on the at least one layer among the layers based on the sign flip rate of the at least one layer; and instructions for updating a binary weight on a weight-updating unfrozen layer, in at least one training epoch performed subsequent to the second training epoch, the weight-updating unfrozen layer excludes at least one weight-updating frozen layer in which the weight-updating is frozen.

### BRIEF DESCRIPTION OF DRAWINGS

The above and other aspects and features of the disclosure will become more apparent by describing in detail illustrative embodiments thereof with reference to the attached drawings, in which:

FIG. 1 is a configuration diagram of a binary neural network model deployment system according to one or more example embodiments of the disclosure;

FIG. 2 is a conceptual diagram for illustrating a method for training a binary neural network model according to one or more example embodiments of the disclosure;

FIG. 3 is a flowchart of a method for training a binary neural network model according to one or more example embodiments of the disclosure;

FIG. 4 is a diagram for illustrating a sign flip rate calculation process that may be performed in one or more example embodiments of the disclosure;

FIG. 5 is a diagram for illustrating change in a sign flip rate based on n in an n-th training epoch;

FIG. 6 and FIG. 7 are example pseudo codes of algorithms of a method for training a binary neural network model according to one or more example embodiments of the disclosure;

FIG. 8 is a flowchart of a method for training a binary neural network model according to one or more example embodiments of the disclosure;

FIG. 9 is a diagram for illustrating an example in which backward propagation stopping or early-stopping of training occurs in accordance with one or more example embodiments of the disclosure;

FIG. 10 to FIG. 13 are diagrams for illustrating a performance test result of a binary neural network model generated through training a binary neural network model according to one or more example embodiments of the disclosure; and

FIG. 14 is a hardware configuration diagram of a computing system according to one or more example embodiments of the disclosure.

### DETAILED DESCRIPTION

Hereinafter, example embodiments of the disclosure will be described with reference to the attached drawings. The advantages and features of the disclosure and methods of accomplishing the same would be understood more readily by reference to the following detailed description of example embodiments and the accompanying drawings. The disclosure may, however, be embodied in many different forms and should not be construed as being limited to the example embodiments set forth herein. Rather, these embodiments are provided so that this disclosure will be thorough and complete and will fully convey the concept of the disclosure to those skilled in the art, and the disclosure will be defined by the appended claims and their equivalents. In describing the disclosure, if it is determined that a detailed description of a related known configuration or function may obscure the gist of the disclosure, the detailed description will be omitted.

The singular expressions used in the following embodiments include plural concepts, unless the context clearly specifies singularity. Additionally, plural expressions include singular concepts, unless the context clearly specifies plurality. In addition, terms such as first, second, A, B, (a), (b) used in the following embodiments are only used to distinguish one element from another element, and the terms do not limit the nature, sequence, or order of the relevant elements.

The elements described with reference to terms such as unit, module, block, ˜or, ˜er, etc. used in the disclosure and the functional blocks shown in the drawings may be implemented in the form of software, hardware, or a combination thereof. For example, the software may be machine code, firmware, embedded code, and application software. For example, the hardware may include an electrical circuit, an electronic circuit, a processor, a computer, an integrated circuit, integrated circuit cores, passive components, or a combination thereof.

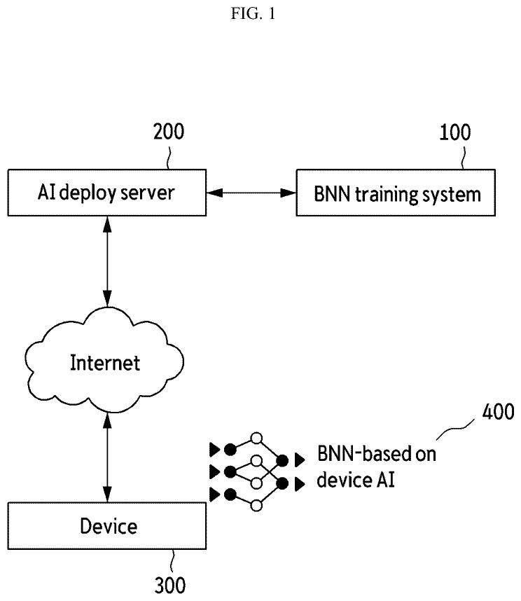

FIG. 1 is a configuration diagram of a binary neural network model deployment system according to one or more example embodiments of the disclosure. A configuration and an operation of a binary neural network model deployment system according to one or more example embodiments of the disclosure will be described with reference to FIG. 1.

As shown in FIG. 1, the binary neural network model deployment system according to one or more example embodiments may include an artificial intelligence (AI) deploy server 200, a binary neural network (BNN) model training system 100, and a device 300. It may be understood that a BNN-based on-device AI 400 generated as a result of a training stage performed by the binary neural network model training system 100 may be deployed to the device 300 through the AI deploy server 200. The binary neural network model deployed by the deploy system according to one or more example embodiments may be the BNN-based on-device AI 400.

The device 300 may be a computing device that provides a low-spec computing environment compared to a server system such as the AI deploy server 200, the BNN training system 100, etc. The device 300 may be, for example, an edge computer, an Internet of things (IoT) device, an embedded device, etc. For example, the device 300 may be a device that is connected to a closed circuit television (CCTV) camera and may analyze an image captured by the camera. The BNN-based on-device AI 400 trained for the purpose of object recognition, scene recognition, behavior analysis, face recognition, vehicle license plate identification, etc. may be deployed into the device 300, and accordingly, the edge computer may perform inferring related to the purpose in a stand-alone scheme.

The device 300 may include a memory and a processor. Parameter information defining the BNN-based on-device AI 400 may be recorded in the memory. That is, when the BNN-based on-device AI 400 has been deployed into the device 300 through the AI deploy server 200, the parameter information may be recorded in the memory of the device 300.

The memory may be embodied as a dynamic random access memory (DRAM). The BNN-based on-device AI 400 may have a binary weight, and a bandwidth for read/write operations of the binary weight may be 1 bit and thus may be very small. Thus, the BNN-based on-device AI 400 may be very compatible with a memory module embodied as the DRAM.

In one example, the parameter information may include weight information of the BNN-based on-device AI 400 and hyperparameter information representing an architecture of the binary neural network model.

Furthermore, the processor of the device 300 may perform BNN operations through in-memory computing. Furthermore, the device 300 may further be equipped with a BNN operation accelerator based on a field programmable gate array (FPGA), and the BNN operation accelerator may be connected to the processor and the memory. For example, the BNN operation accelerator may include a logic for accelerating an XNOR operation which accounts for a large proportion of the BNN operations. As described above, the device 300 may be configured to have a low-spec computing resource while being optimized for executing an inferring stage of the BNN-based on-device AI 400.

The binary neural network model training system 100 may perform a training process for generating or additionally training the BNN-based on-device AI 400. The training stage may include performing a first training epoch that updates the binary weight of each of layers constituting the binary neural network model using training data, performing a second training epoch that updates the binary weight of each of the layers constituting the binary neural network model, calculating a sign flip rate (SFR) in the second training epoch on at least a portion of the layers (or at least one layer of the layers), determining whether to freeze the weight updating on the at least a portion of the layers using the sign flip rate of each of the layers, and updating of the binary weight of an unfrozen layer excluding the layer on which the weight updating is frozen among the layers, in one or more training epochs performed after the second training epoch.

The meaning of the sign flip rate is briefly described. A sign flip rate SFREL in an E epoch of an L layer means a ratio of a number of a specific binary weight to a number of all of binary weights of the L layer, wherein a sign of the specific binary weight in an E-1 training epoch and a sign of the specific binary weight in an E training epoch flip each other. A low sign flip rate SFREL of the L layer means that the sign of the L layer in the E training epoch is unlikely to flip to be different from the sign in the E-1 training epoch.

The binary weight may be a value obtained by binarizing a latent weight of a real number value using a sign function, etc. Thus, even when the latent weight is updated, a sign of a resulting binary weight does not change unless the updated latent weight exceeds a binarization threshold. During the training process performed while repeating the training epoch, when a gradient of the latent weight reaches a saturation point, a frequency in which the latent weight is updated and a change in a value thereof decrease in a training epoch in a latter part of the training process. Therefore, understanding the relationship between the latent weight and the sign flip rate in the binary neural network model is very important for optimizing the training process and improving the performance of the binary neural network model. Through this understanding, a weight updating rule performed in each training epoch may be adjusted based on the sign flip rate, thereby optimizing the training process and improving the performance of the binary neural network model.

When a size of the gradient of the latent weight reaches a saturation point during the training process, the weight updating may be minimized in the latter part of the training process. In the binary neural network model, a sensitivity to weight change may be reduced due to the sign function, and computations related to weight updating may become useless unless the sign changes beyond a threshold value. Considering this fact, weight updating on at least a portion of the layers (or at least one layer of the layers) constituting the binary neural network model may be determined to be frozen based on the sign flip rate indicating how active the sign flip of the binary weight is. The layer on which the weight updating is frozen may be a layer on which the binary weight is less likely to be updated. Thus, an operation for updating the binary weight may not be performed on the layer on which the weight updating is frozen, such that a training process execution speed may be increased, and/or the training process may be performed even on a device with limited resources.

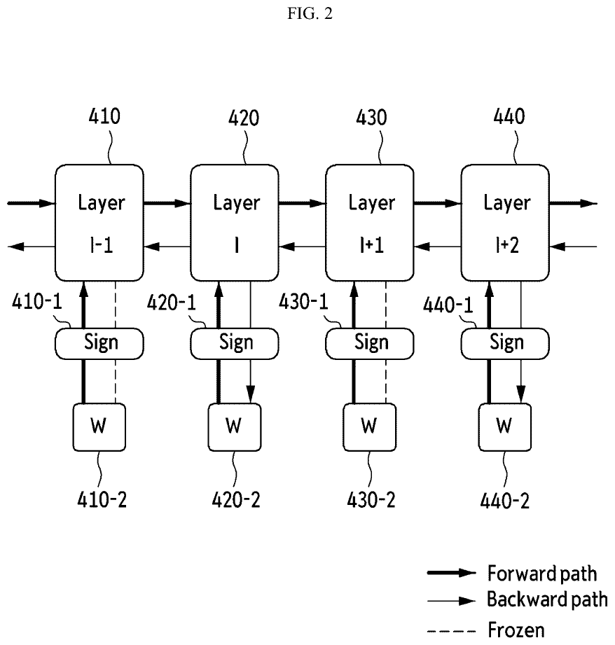

FIG. 2 is a conceptual diagram for illustrating a method for training a binary neural network model according to one or more example embodiments of the disclosure. With reference to FIG. 2, the training process execution process when at least one of the layers constituting the binary neural network model is determined as a layer on which the weight updating is frozen in one or more example embodiments of the disclosure is described. The example binary neural network model of FIG. 2 may include a layer l−1 410, a layer l 420, a layer l+1 430, and a layer l+2 440 sequentially arranged. As described above, respective latent weight 410-2, 420-2, 430-2, and 440-2 of the layers 410, 420, 430, and 440 may be updated in a backward propagation process. Sign functions 410-1, 420-1, 430-1, and 440-1 may be respectively applied to the updated latent weight 410-2, 420-2, 430-2, and 440-2 to calculate the binarized weight of the layers 410, 420, 430, and 440. However, the operation for updating the latent weight 410-2, 420-2, 430-2, and 440-2 and the operation for applying the sign functions 410-1, 420-1, 430-1, and 440-1 to the latent weight 410-2, 420-2, 430-2, and 440-2 on the layers 410 and 430 on which the weight updating is frozen may be omitted (that is, may not be performed).

As will be described later, a performance degradation of the binary neural network model may not be significant even when the weight updating is not performed on the layers 410 and 430 on which the weight updating is frozen. On the other hand, the computational saving related to the layers 410 and 430 on which the weight updating is frozen may be significant. Therefore, the method for training the binary neural network model according to the disclosure may provide the effect of reducing the performance degradation while increasing the computational saving.

Hereinafter, a method for training a binary neural network model according to another embodiment of the disclosure will be described. The method for training the binary neural network model according to the present embodiment may be performed by a computing device or a computing system including multiple computing devices. For example, the method for training the binary neural network model according to the present embodiment may be performed by the binary neural network model training system 100 or the device 300 as described with reference to FIG. 1. The method for training the binary neural network model according to one or more embodiments may be characterized by reducing the computational load such that the method may be performed not only by the binary neural network model training system 100 but also by the device 300 having a low-spec computing environment. The computational load saving amount may be increased or decreased by adjusting various reference values as described below.

Furthermore, the method for training the binary neural network model according to the present embodiment may be performed via collaboration between a first computing device and a second computing device. For example, the first computing device having a high-spec computing environment may perform a training epoch at a starting point to a predetermined n-th training epoch, while remaining training epochs may be performed by the second computing device having a low-spec computing environment.

For example, the first computing device may be the binary neural network model training system 100 as described with reference to FIG. 1, and the second computing device may be the device 300 as described with reference to FIG. 1. The second computing device may receive data of the binary neural network model including a number of layers on which weight updating is frozen from the first computing device, and may perform weight updating on the remaining training epochs using training data acquired by the second computing device itself.

That is, it would be understood that the first computing device may train the binary neural network model as a pre-trained model, and the second computing device may receive the pre-trained model from the first computing device, and then additionally train the binary neural network model for fine tuning. As described above, in the training epoch in the latter part of the training process, a size of the gradient may reach the saturation point, thereby minimizing weight updating. As a result, the number of layers on which weight updating is frozen may increase. On the layer on which weight updating is frozen, no real number operation is required for updating the latent weight, and no binarization operation via applying the sign function to the updated latent weight is required. Therefore, the amount of computation required for the fine-tuning may be significantly reduced compared to the amount of computation required for generating the pre-trained model. Therefore, even the second computing device with the low level specification may fine-tune the pre-trained model on its own.

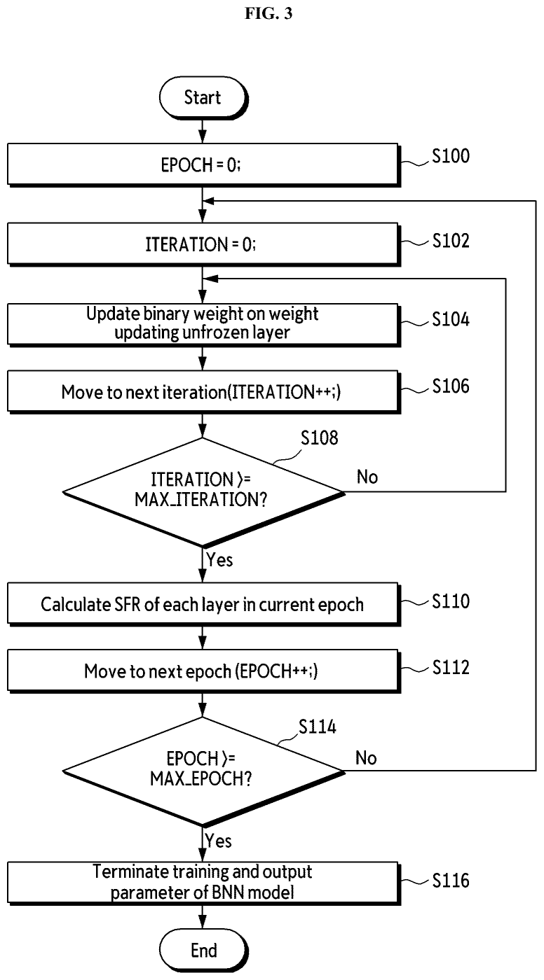

In one or more example embodiments, the first computing device may obtain hardware specification information of the second computing device, score a computational resource possession level of the second computing device based on the specification information, and may increase or decrease a computational load saving amount for fine-tuning of the binary neural network model based on the computational resource possession level. For example, when the computational resource possession level of the second computing device is below a reference value, the first computing device may adjust one or more reference values related to criteria based on which the weight updating is determined to be frozen such that the criteria based on which the weight updating is determined to frozen may be relaxed and the pre-trained model with a larger number of layers on which the weight updating is frozen may be generated. Descriptions regarding the reference value adjustment will be set fourth through embodiments as described with reference to FIGS. 3 to 9.

Hereinafter, when a description of a subject that performs each operation is omitted, it would be understood that the subject of the operation may be the computing device or the computing system.

FIG. 3 is a flowchart of a method for training a binary neural network model according to one or more example embodiments of the disclosure.

Referring to FIG. 3, in steps S100 and S102, the training epoch and an iteration in the training epochs may be initialized.

FIG. 3 illustrates an example in which entire training data may be divided into batches, and one time training epoch may be completed by repeating, a number of iterations, the updating of the binary weight of the binary neural network model using training data of each batch. In another example, one time training epoch may be completed by passing the entire training data through the binary neural network model at once. In this case, operations related to initialization of the iteration in S102, movement to a next iteration in S106, and determining of whether the training epoch is completed through the completion of the iteration in S108 in FIG. 3 may not be performed.

In step S104, forward propagation and backward propagation for updating the binary weight may be performed on the weight-updating unfrozen layer excluding the layer(s) on which the weight updating is frozen among the layers included in the binary neural network model. An initial state of each of the layers included in the binary neural network model may be in an unfrozen state in which the weight updating on each layer is not frozen. Therefore, forward propagation and backward propagation for updating the binary weight may be performed on all layers included in the binary neural network model in a first training epoch.

As a value of n in an n-th training epoch increases, some layers included in the binary neural network model may be determined to be placed in a frozen state in which weight updating thereon is frozen, and in this case, forward propagation and backward propagation for updating the binary weight may be performed only on a layer in which the weight-updating is determined to be unfrozen (hereinafter, referred to as “weight-updating unfrozen layer”) in S104. More specifically, forward and backward propagations for updating the binary weight, gradient calculation using the latent weight having a real number value, updating the latent weight using the calculated gradient and the optimization algorithm, and updating the binary weight by applying the updated latent weight to the binarization function may be performed only on the weight-updating unfrozen layer. That is, the above-described operations related to the backward propagation for updating the binary weight may not be performed on a layer in which the weight-updating is determined to be frozen (hereinafter, referred to as “weight-updating frozen layer”). As a result, the method for training the binary neural network model according to the disclosure may provide a computational resource saving effect.

The operation S104 in which the forward propagation and backward propagation to update the binary weight is performed on the weight-updating unfrozen layer may be performed as many times as a number of iterations MAX ITERATION determined to complete one time training epoch, in S106 and S108.

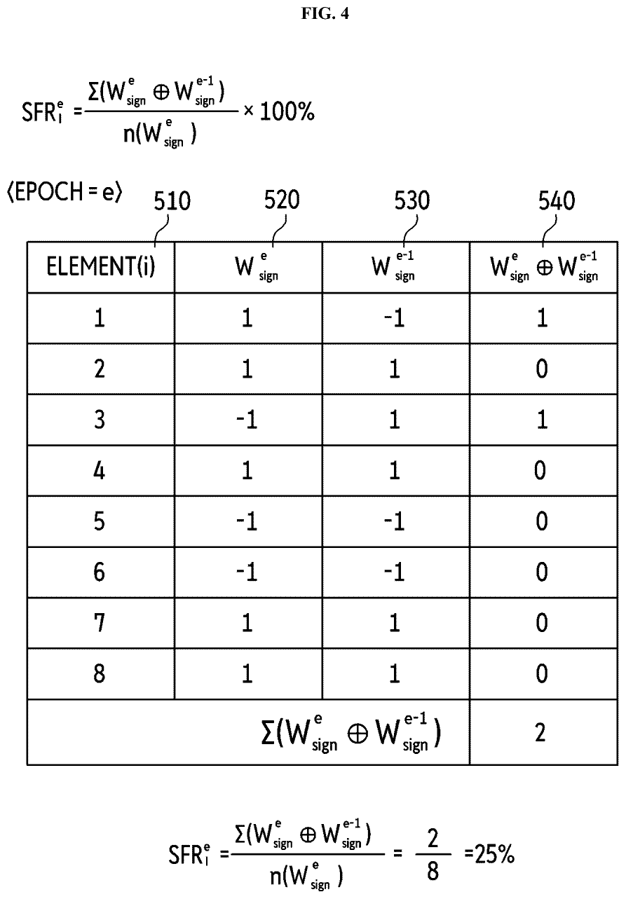

In step S110, the sign flip rate of each layer in a current training epoch may be calculated. The calculation of the sign flip rate will be described later with reference to FIG. 4. FIG. 4 is a diagram for illustrating a sign flip rate calculation process that may be performed in one or more example embodiments of the disclosure. The example illustrated in FIG. 4 is based on assumption that one time training epoch is completed by passing the entire training data through the binary neural network model at once. In other words, it is noted that the example illustrated in FIG. 4 is based on assumption that one time training epoch is completed with only one time iteration.

The sign flip rate SFR^{e}ₗ of a l layer in an e epoch means a ratio of a number of a specific binary weight to a number of all binary weights

$$n ( {W}_{sign}^{e} )$$

of the l layer, wherein a sign of the specific binary weight in an e-1 training epoch as an immediately previous training epoch and a sign in the specific training epoch in the e training epoch as the current training epoch flip each other. Therefore, SFR^{e}ₗ may be defined as a value obtained by dividing

$$\sum ( {W}_{sign}^{e} ⊕ {W}_{sign}^{e - 1} ) by n ( {W}_{s i g n}^{e} ) , wherein \sum ( {W}_{sign}^{e} ⊕ {W}_{sign}^{e - 1} )$$

is obtained by summing respective

$$\sum ( {W}_{sign}^{e} ⊕ {W}_{sign}^{e - 1} )$$

values of binary weights included in the l layer in an element-wise scheme.

In the embodiment of FIG. 4, a total of 8 binary weights may be included in the l layer (a dimension of the l layer=8), and a sum of values obtained by an XOR operation of the respective signs in the immediately previous training epoch and the respective signs in the current training epoch of the 8 binary weights may be 2. Thus, SFR^{e}ₗ may be calculated as 25% (a ratio of 2 to 8). The eight binary weights of the l layer as described with reference to FIG. 4 may mean eight binary weights connected to each other and disposed between the l layer and the (l−1) layer in the backward propagation process.

In one or more example embodiments, whether the weight updating on the layer is to be frozen may be determined based on the sign flip rate of the layer. As described above, the gradient of the latent weight affects the sign flip rate, and thus the sign flip rate may be used as a reference indicator for determining whether the weight updating on the layer is to be frozen.

For example, only a layer with the sign flip rate of 0% may be determined to be the weight-updating frozen layer, that is, a layer on which the weight updating is frozen. In this case, it would be understood that the most stringent weight updating freezing condition is applied.

In another example, a layer of which the sign flip rate is lower than or equal to a pre-specified freezing reference value may be determined to be the weight-updating frozen layer. The freezing reference value may be defined as a value that may be specified and adjusted by a user. It would be understood that as the freezing reference value is set to a lower value, a stricter weight updating freezing condition is applied. On the other hand, as the freezing reference value is set to a higher value, a relaxed weight updating freezing condition is applied

In one or more example embodiments, the freezing reference value may be a fixed value maintained in all training epochs repeated through the training process.

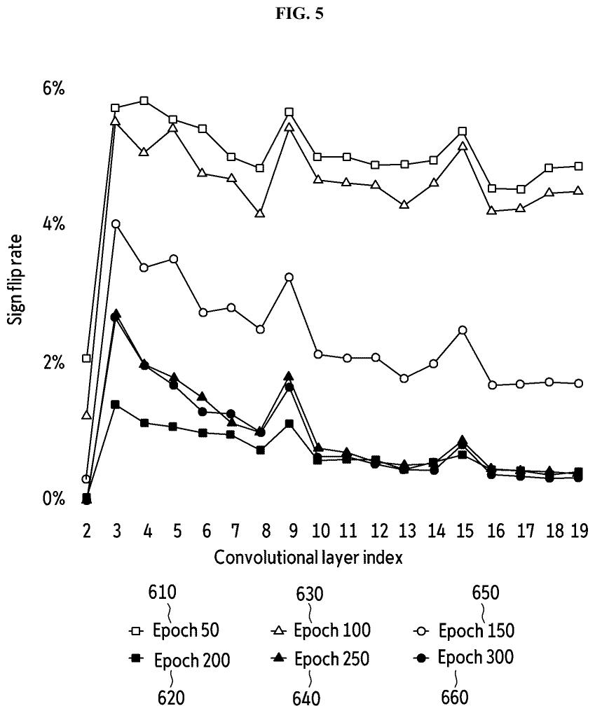

In some embodiments, the freezing reference value may be a variable reference value that automatically changes as the value of n in an n-th training epoch repeated through the training process increases. That is, the freezing reference value may be a variable reference value determined based on a number of a round of the training epoch. FIG. 5 is a diagram for illustrating change in a sign flip rate based on n in an n-th training epoch. Referring to FIG. 5, it may be identified that as the value of n in an n-th training epoch increases, the size of the gradient reaches the saturation point, and as the value of n in an n-th training epoch increases, the sign flip rate decreases. That is, as shown in FIG. 5, the sign flip rate of a 50th training epoch 610 has a significantly higher value than the sign flip rate of the 300th training epoch 660.

According to the example shown in FIG. 5, the sign flip rates of the early training epochs 610 and 630 have a high level rate across all of the layers, the sign flip rate of the middle training epoch 650 has an intermediate level rate across all of the layers, and the sign flip rates of the later training epochs 620, 640, and 660 have a low level rate across all of the layers.

Considering the correlation between the value of n in an n-th training epoch and the sign flip rate as described with reference to FIG. 5, the freezing reference value may be automatically changed such that the freezing reference value becomes smaller as the value of n in the n-th training epoch as the current training epoch approaches a pre-designated number of epochs that causes training termination. That is, the freezing reference value may be a variable reference value that varies so as to have a smaller value as the number of the round approaches a predetermined number of epochs of the training termination. When the freezing reference value is maintained at a fixed value in all training epochs repeated through the training process, most of the layers may be determined as the weight-updating frozen layer in the later training epochs, and in this case, the precision of the binary weight of the binary neural network model may be reduced.

Referring back to FIG. 3, description will be made.

The forward propagation and backward propagation to update the binary weight may be performed only on the weight-updating unfrozen layer in S104, the sign flip rate of each of the layers may be calculated in the current training epoch in S110, and the calculated sign flip rate may be used to determine whether the weight updating on each of the layers is to be frozen. These operations may be repeated until a pre-designated number of training epochs are completed, in S112 and S114. When the pre-designated number-th training epoch is completed, the training process may be completed, and the parameters of the binary neural network model may be output as a training result in S116.

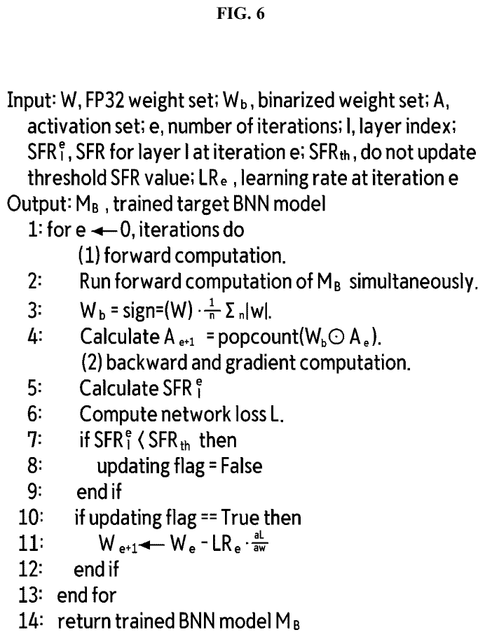

FIG. 6 shows a pseudo code of an algorithm for performing a training process according to one or more example embodiments. The algorithm illustrated in FIG. 6 indicates that one time training epoch including operations related to forward propagation (lines 2 to 4) and backward propagation on the weight-updating unfrozen layer (lines 6 to 12), and determining whether to freeze updating of a layer (e.g., layer l) based on the sign flip rate (lines 7 to 8) is repeated e times (line 1).

In one example, in one or more example embodiments, whether to freeze weight updating on each of the layers may be determined using a moving average of the sign flip rates corresponding to an epoch window formed based on the current training epoch. When whether to freeze weight updating on a first layer may be determined based on the moving average of the sign flip rates of the first layer, rather than the sign flip rate of the first layer itself, whether to freeze the weight updating on the first layer may be prevented from being incorrectly determined when the data of the current training epoch indicates an abnormal sign flip rate.

The pseudo code of the algorithm for performing the training process based on the moving average of the sign flip rates is illustrated in FIG. 7. The algorithm illustrated in FIG. 7 indicates that one time training epoch including operations related to forward propagation (lines 2 to 4) and backward propagation on the weight-updating unfrozen layer (lines 6, and 13 to 15), and determining whether to freeze updating based on the moving average of the sign flip rate (lines, 5 and 7 to 12) is repeated e times (line 1).

An example of determining whether to freeze the weight updating on the first layer of the binary neural network model is described by way of example.

First, it is determined whether a difference between moving averages of the sign flip rates of the current training epoch and the immediately previous training epoch of the first layer is smaller than a predetermined moving average difference value (delta) (line 7). When the difference between the moving averages of the sign flip rates of the current training epoch and the immediately previous training epoch is smaller than the predetermined moving average difference value (delta), a counter (patient) indicating a number of times the difference is smaller than the moving average difference value (delta) may be increased (line 8).

When the counter (patient) indicating a number of epochs, which continuously maintain a state in which the difference between the moving averages of the sign flip rates of the current training epoch and the immediately previous training epoch of the first layer is smaller than the predetermined moving average difference value, reaches a predetermined patience value, the first layer may be determined as a layer on which the weight-updating is to be frozen. In FIG. 7, the patience value is set as ‘5’ (line 10) in one example. In one or more example embodiments, the patience value may be a variable reference value determined based on the value of n in the n-th training epoch as the current training epoch. For example, the patience value may be automatically changed such that the patience value increases as the value of n in the n-th training epoch as the current training epoch approaches z in a z-th training epoch as a pre-designated training end epoch.

When a state in which the change in the moving average of the sign flip rate under the repetition of the epoch in the first layer is maintained to be smaller than the moving average difference value (delta) is maintained for n number of training epochs, the wherein n is greater than or equal to the patience value, this means that the first layer may be determined as a layer on which the weight-updating is to be frozen with a higher reliability. Therefore, the training process performed according to the algorithm described with reference to FIG. 7 may be executed in a manner such that the deterioration of the performance of the binary neural network model is minimized.

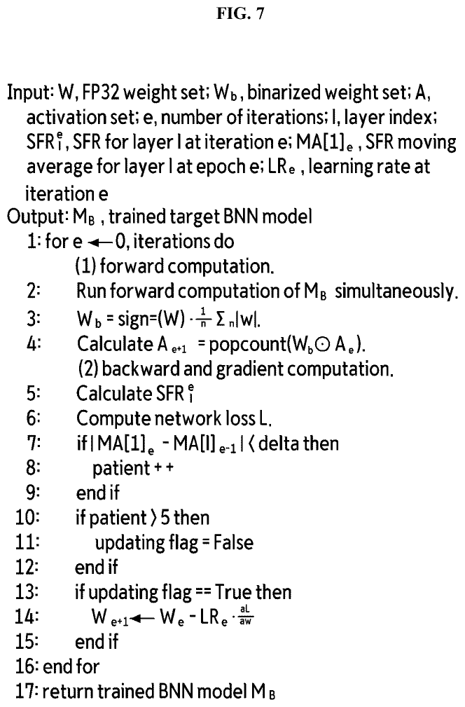

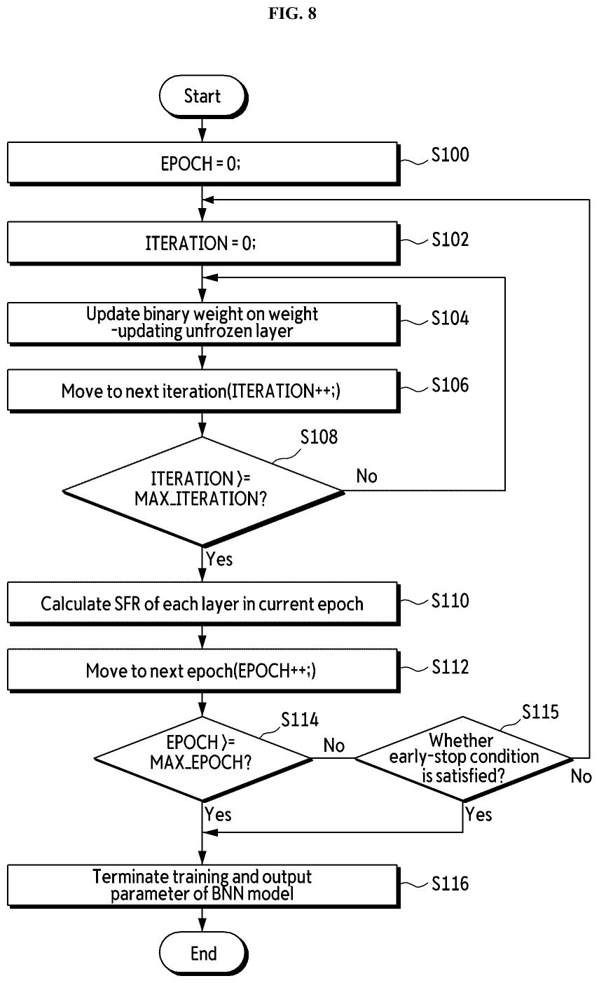

In one or more example embodiments, whether to early-stop the training process may be determined based on the sign flip rate. FIG. 8 is another flowchart of a method for training a binary neural network model according to one or more example embodiments. FIG. 8 illustrates that when each training epoch is completed, an operation S115 for determining whether to early-stop the training process may be additionally performed. Upon determination to early-stop the training process ('Yes' at S115), an operation S116 for terminating the training process and outputting the parameters of the binary neural network model may be performed even when the pre-designated number-th training epoch is not completed.

In one or more example embodiments, whether to early-stop the training process of the binary neural network model may be determined using the sign flip rate of at least one layer among the layers of the binary neural network model. For example, when the average of the sign flip rates of all layers of the binary neural network model is smaller than a reference value, the method may early-stop the training process of the binary neural network model. In another example, when a ratio of a number of the layers determined as a layer on which the weight-updating is to be frozen based on the sign flip rate to a number of all layers of the binary neural network model is greater than a reference value, the method may early-stop the training process of the binary neural network model.

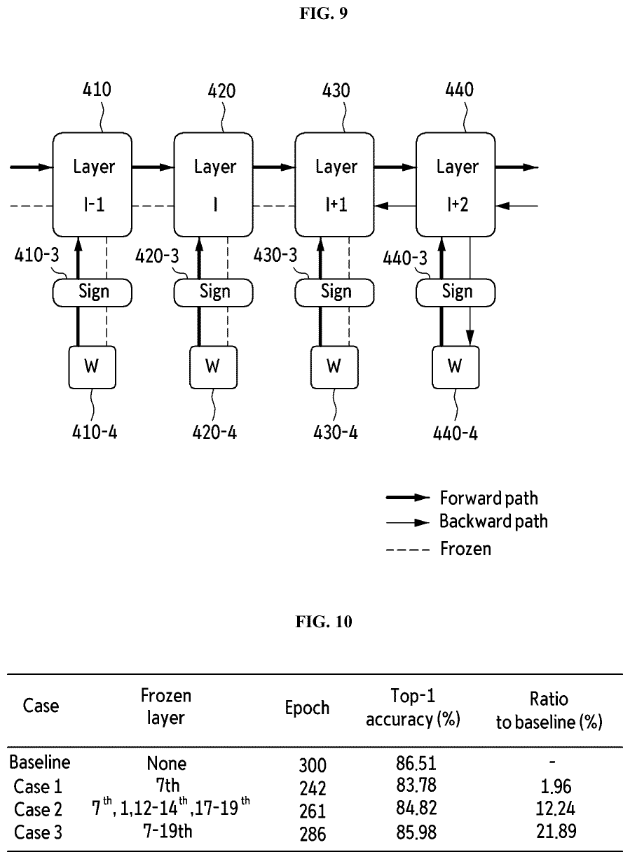

FIG. 9 is a diagram for illustrating an example in which backward propagation stopping or early-stopping of training occurs in accordance with one or more example embodiments of the disclosure. As shown in FIG. 9, when the weight-updating is frozen on consecutive layers including a first layer to an n-th layer (n being a natural number equal to or greater than 2 and smaller than the number of all layers of the binary neural network model), the method may determine to perform backward blocking at a (n+1)-th layer. In one or more example embodiments, when, due to the backward blocking, a length of the backward propagation is shorter than a reference value, the method may early-stop the training process of the binary neural network model. That is, the method may determine whether to early-stop the training process of the binary neural network model, based on a number of layers positioned between the (n+1)-th layer and the last layer of the binary neural network model. The number of layers positioned between the (n+1)-th layer and the last layer of the binary neural network model may mean the length of the backward propagation. For example, when the length of the backward propagation is smaller than 5% of the total layers, the method may early-stop the training process of the binary neural network model.

In an example binary neural network model as illustrated in FIG. 9, layers l−1, l, and l+1 410, 420, and 430 may be consecutively in an updating frozen state, and the layer l+2 440 may become the last layer in the backward propagation. In this case, updating the latent weights 410-4, 420-4, and 430-4 on the layers in the updating frozen state and the binarization operation including applying the updated latent weights 410-4, 420-4, and 430-4 to the sign functions 410-3, 420-3, and 430-3 may not be performed.

According to the one or more example embodiments as described so far, an example in which a layer determined to be the weight-updating frozen layer in a specific training epoch continues to be in the weight-updating frozen state until the end of the training process is described. However, in one or more example embodiments, a layer among the layers on which the weight updating is frozen, which satisfies a pre-specified condition, may be changed back to the weight-updating unfrozen layer, thereby allowing the weight updating to be performed again in such a layer in the backward propagation.

For example, the pre-specified condition may be met when the sign flip rates of a predetermined number of adjacent layers to the first layer among the layers on which the weight-updating is frozen exceed a predetermined reference value for changing to the weight-updating unfrozen state, and thus, the first layer may be changed back to the weight-updating unfrozen layer. The adjacent layers may be configured, for example, to include M (M being a natural number equal to or greater than one) layer(s) in each of the forward and backward directions from the first layer. This embodiment takes into consideration the fact that when the sign flips of the adjacent layers become active (or frequent) such that the sign flip rates of the adjacent layers exceed the reference value for changing to the weight-updating unfrozen state, it is highly likely that the weight of the first layer needs to be updated.

Furthermore, the predetermined condition may be satisfied when a performance metric of the binary neural network model measured after one or more training epochs performed after the training epoch in which the first layer has been determined as the weight-updating frozen layer is lower than a reference value. That is, when the performance metric falls below the reference value, weight updating may be performed again for the first layer. In this regard, a predefined number of layers may be selected among the weight-updating frozen layers to be switched to the weight-updating unfrozen layers in a reverse order to an order in which the weight-updating is frozen in the predefined number of layers.

Hereinafter, a performance test result of the method for training the binary neural network model according to one or more example embodiments of the disclosure are described with reference to FIGS. 10 to 14.

As shown in FIG. 10, on an example binary neural network model including a total of 20 layers, a Top-1 accuracy of a baseline case in which the weight-updating frozen layer is absent and 300 training epochs are performed is 86.51%. A Top-1 accuracy of a third case in which weight-updating is frozen on all of 7th to 19th layers and only 286 training epochs are performed and then the training process early stops is 85.98%. That is, a difference therebetween is merely 0.53%. However, a ratio of a computational amount of the third case to that of the baseline case was measured to be 21.89%. That is, despite the reduction of the computational amount by 21.89%, the decrease in the accuracy is merely 0.53%. Thus, it may be identified that the binary neural network model training method of the one or more embodiments according to the disclosure is highly efficient.

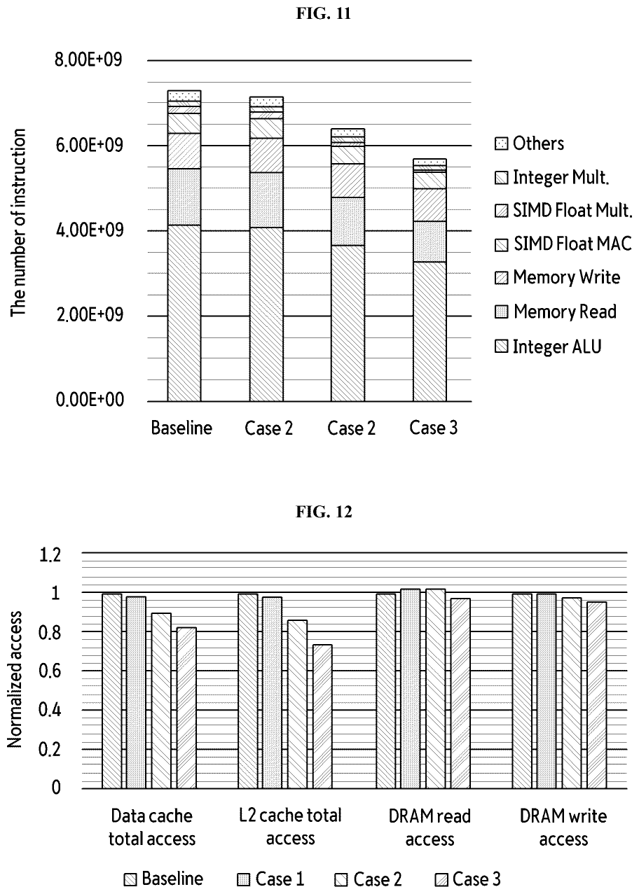

FIG. 11 shows a computational amount reduction based on a type of an operation. Referring to FIG. 11, it may be identified shows that a number of instructions in the third case based on each of various operation types is reduced, compared to that in the baseline case.

FIG. 12 shows a computational amount reduction based on a type of an access made during the training process of the disclosure. Referring to FIG. 12, it may be identified that a number of accesses to each of a data cache and an L2 cache in the third case is significantly reduced compared to the number of accesses to each of the data cache and the L2 cache in the baseline case.

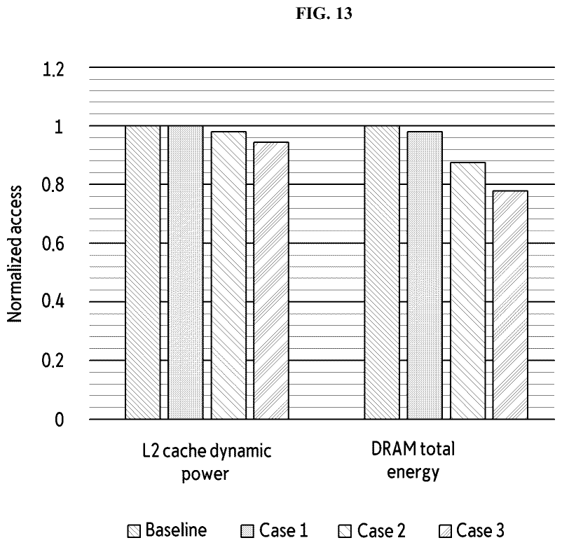

Furthermore, as illustrated in FIG. 13, it may be identified that a DRAM energy usage of the third case is significantly reduced compared to a DRAM energy usage of the baseline case during the training process according to one or more embodiments of the disclosure.

The technical ideas that may be understood through the one or more embodiments described with reference to FIGS. 1 to 13 so far may be applied to other embodiments as described later without being specifically stated.

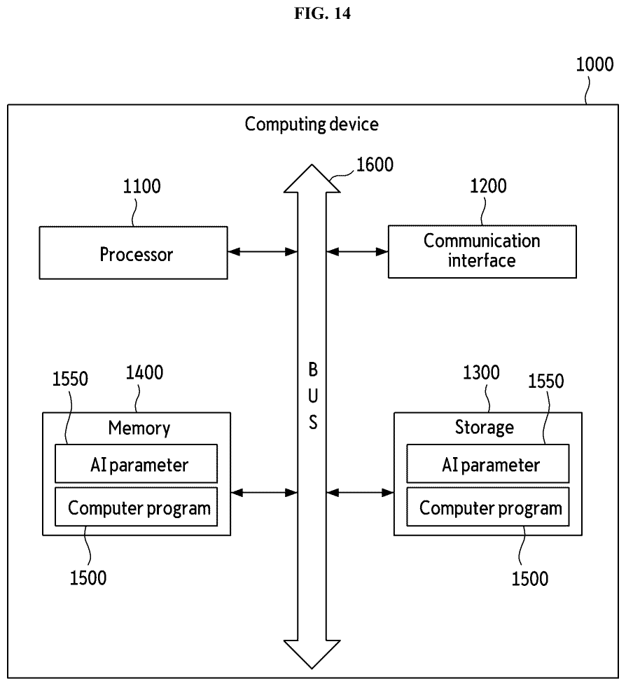

FIG. 14 is a hardware configuration diagram of a computing system 1000 according to one or more example embodiments of the disclosure. The computing system 1000 of FIG. 14 may refer to, for example, the binary neural network model training system 100 as described above with reference to FIG. 1. The computing system 1000 may include one or more processors 1100, a system bus 1600, a communication interface 1200, a memory 1400 that loads therein a computer program 1500 executed by the one or more processors 1100, and a storage 1300 that stores therein the computer program 1500. The computing system 1000 may be provisioned through a cloud service, in which case all of the one or more processors 1100, the communication interface 1200, the memory 1400, and the storage 1300 may be virtual resources.

Furthermore, the storage 1300 may include therein parameter data 1550 that defines the binary neural network model trained by the computer program 1500. When the computer program 1500 is loaded into the memory 1400 and executed by the one or more processors 1100, the parameter data 1550 together therewith may be loaded into the memory 1400. The memory 1400 may be configured to include one or more DRAM modules.

The one or more processors 1100 may control all operations of components of the computing system 1000. The one or more processors 1100 may perform computations on at least one application or program to execute method(s) and/or operation(s) according to various embodiments of the disclosure. The memory 1400 may store therein various data, commands, and/or information. The memory 1400 may load therein the one or more computer programs 1500 from the storage 1300 to execute method(s)/operation(s) according to various embodiments of the disclosure. The system bus 1700 may provide a communication function between the components of the computing system 1000. The communication interface 1200 may support Internet communication of the computing system 1000. The storage 1300 may non-temporarily store therein the one or more computer programs 1500.

The computer program 1500 may include one or more instructions by which method(s)/operation(s) according to various embodiments of the disclosure are implemented. When the computer program 1500 is loaded into the memory 1400, the one or more processors 1100 may execute the one or more instructions to perform method(s)/operation(s) according to various embodiments of the disclosure.

The computer program 1500 may include instructions for performing a first training epoch for updating a binary weight of each of layers constituting the binary neural network model using training data; instructions for performing a second training epoch for updating the binary weight of each of the layers constituting the binary neural network model; instructions for calculating a sign flip rate in the second training epoch on at least one layer of the layers; instructions for determining whether to freeze weight-updating on the at least one layer of the layers based on the sign flip rate of the at least one layer; and instructions for updating a binary weight on a weight-updating unfrozen layer excluding a weight-updating frozen layer among the layers, in at least one training epoch performed subsequent to the second training epoch. The second training epoch may be an epoch immediately subsequent to the first training epoch.

In one example, the computing device 1000 of FIG. 14 may be a device into which the binary neural network model is deployed. An example of the device into which the binary neural network model is deployed has been described with reference to FIG. 1. In this case, parameter information defining the binary neural network model may be received through the communication interface 1200 and loaded into the memory 1400.

Various example embodiments of the disclosure and effects according to the example embodiments have been described with reference to FIGS. 1 to 14. The effects according to the technical idea of the disclosure are not limited to the effects mentioned above, and other effects not described may be clearly understood by those skilled in the art from the description above.

The technical ideas of the disclosure described so far may be implemented as computer-readable code on a computer-readable medium. The computer program recorded on the computer-readable recording medium may be transmitted to another computing device through a network such as the Internet, installed on the other computing device, and thus used on the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. Although embodiments of the disclosure have been described above with reference to the attached drawings, those skilled in the art will understand that the disclosure may be implemented in other specific forms without changing the technical idea or essential features. The example embodiments described above should be understood in all respects as illustrative and not restrictive. The scope of protection of the disclosure should be interpreted in accordance with the claims below, and all technical ideas within the equivalent scope should be construed as being included in the scope of rights of the technical ideas defined by this disclosure.

What is claimed is:

1. A method for training a binary neural network (BNN) model, the method being performed by a computing system, the method comprising:
performing a first training epoch including updating a binary weight of each of layers constituting the binary neural network model using training data;
performing a second training epoch including updating the binary weight of each of the layers constituting the binary neural network model, wherein the second training epoch is an epoch immediately subsequent to the first training epoch;
obtaining a sign flip rate of at least one layer among the layers in the second training epoch;
determining whether to freeze weight-updating on the at least one layer among the layers based on the sign flip rate of the at least one layer; and
updating a binary weight on a weight-updating unfrozen layer in at least one training epoch performed subsequent to the second training epoch, wherein the weight-updating unfrozen layer excludes at least one weight-updating frozen layer in which the weight-updating is frozen.

2. The method of claim 1, wherein the updating the binary weight on the weight-updating unfrozen layer includes performing operations only on the weight-updating unfrozen layer, and
wherein the operations include:
performing a forward propagation and a backward propagation for updating the binary weight;
obtaining a gradient using a latent weight having a real number value;
updating the latent weight based on the obtained gradient and an optimization algorithm; and
applying the updated latent weight to a binarization function.

3. The method of claim 1, wherein the determining whether to freeze the weight-updating includes determining a layer having the sign flip rate of 0% to be a weight-updating frozen layer.

4. The method of claim 1, wherein the determining whether to freeze the weight-updating includes determining a layer having the sign flip rate lower than or equal to a predetermined freezing reference value to be a weight-updating frozen layer.

5. The method of claim 4, wherein the predetermined freezing reference value has a value that varies based on a number of a round of the second training epoch.

6. The method of claim 5, wherein the predetermined freezing reference value has a value that varies such that the value decreases as n in an n-th (n being a natural number equal to or greater than 2) training epoch, which is the second training epoch, approaches z in a z-th training epoch, which is a predetermined training end epoch.

7. The method of claim 1, wherein the obtaining the sign flip rate includes obtaining a sign flip rate of a first layer included in the at least one layer among the layers, and
wherein the sign flip rate of the first layer is a ratio of a number of a specific binary weight to a number of all of binary weights of the first layer, wherein a sign of the specific binary weight of the first layer in the first training epoch and a sign of the specific binary weight of the first layer in the second training epoch flip each other.

8. The method of claim 1, wherein the updating the binary weight on the weight-updating unfrozen layer includes determining to perform backward blocking at an (n+1)-th layer based on the weight-updating being frozen on consecutive layers including a first layer to an n-th (n being a natural number equal to or greater than 2) layer.

9. The method of claim 8, wherein the determining to perform the backward blocking includes determining whether to perform early-stopping of the training of the binary neural network model based on a number of layers positioned between the (n+1)-th layer and a last layer of the binary neural network model.

10. The method of claim 1, further comprising determining whether to perform early-stopping of the training of the binary neural network model, based on the sign flip rate of the at least one layer among the layers.

11. The method of claim 1, wherein the updating the binary weight on the weight-updating unfrozen layer includes switching a first layer satisfying a pre-specified condition among the at least one weight-updating frozen layer to be the weight-updating unfrozen layer.

12. The method of claim 11, wherein the pre-specified condition is satisfied based on sign flip rates of a pre-specified number of layers adjacent to the first layer exceeding a pre-specified reference value for switching a layer to the weight-updating unfrozen layer.

13. The method of claim 1, wherein the updating the binary weight on the weight-updating unfrozen layer includes:
based on a performance metric of the binary neural network model, measured after performing the at least one training epoch subsequent to the second training epoch, being lower than a reference value, switching at least one of the at least one weight-updating frozen layer to the weight-updating unfrozen layer.

14. The method of claim 13, wherein the switching the at least one of the at least one weight-updating frozen layer to the weight-updating unfrozen layer includes switching, to the weight-updating unfrozen layer, a predetermined number of layers selected among the at least one weight-updating frozen layer in a reverse order to an order in which the weight-updating is frozen in the predetermined number of layers.

15. The method of claim 1, wherein the determining whether to freeze the weight-updating includes:
obtaining a moving average of the sign flip rate corresponding to an epoch window formed based on the second training epoch, on the at least one layer among the layers; and
determining whether to freeze the weight-updating on the at least one layer among the layers, based on the obtained moving average of the sign flip rate.

16. The method of claim 15, wherein the at least one layer among the layers include a first layer, and
wherein the determining whether to freeze the weight-updating on the at least one layer among the layers, based on the obtained moving average of the sign flip rate includes:
determining whether to freeze the weight-updating on the first layer, based on whether a difference between the moving average of the sign flip rate of the first layer in the second training epoch and the moving average of the sign flip rate of the first layer in the first training epoch is smaller than a predetermined moving average difference value.

17. The method of claim 16, wherein the determining whether to freeze the weight-updating on the first layer includes:
based on a number of epochs, which maintain a state in which a difference between a moving average of the sign flip rate of a current training epoch and a moving average of the sign flip rate of a training epoch immediately previous to the current training epoch is smaller than the predetermined moving average difference value, reaching a predetermined patience value, determining to freeze the weight-updating on the first layer.

18. The method of claim 17, wherein the predetermined patience value has a value that varies based on a value of n in an n-th (n being a natural number equal to or greater than 2) training epoch, which is the second training epoch.

19. A method for deploying a binary neural network model into a device having a dynamic random access memory (DRAM), the method comprising:
obtaining parameter information that defines the binary neural network model; and
recording the parameter information into the DRAM,
wherein the binary neural network model has been pre-generated by performing a training process, and
wherein the training process includes:
performing a first training epoch for updating a binary weight of each of layers constituting the binary neural network model using training data;
performing a second training epoch for updating the binary weight of each of the layers constituting the binary neural network model, wherein the second training epoch is an epoch immediately subsequent to the first training epoch;
obtaining a sign flip rate of at least one layer among the layers in the second training epoch;
determining whether to freeze weight-updating on the at least one layer among the layers based on the sign flip rate of the at least one layer; and
updating a binary weight on a weight-updating unfrozen layer, in at least one training epoch performed subsequent to the second training epoch, wherein the weight-updating unfrozen layer excludes at least one weight-updating frozen layer in which the weight-updating is frozen.

20. A computing system for training a binary neural network model, the computing system comprising:
a memory configured to load therein parameter information that defines the binary neural network model and a program for training the binary neural network model; and
at least one processor configured to execute the program loaded in the memory,
wherein the program includes:
instructions for performing a first training epoch for updating a binary weight of each of layers constituting the binary neural network model using training data;
instructions for performing a second training epoch for updating the binary weight of each of the layers constituting the binary neural network model, wherein the second training epoch is an epoch immediately subsequent to the first training epoch;
instructions for obtaining a sign flip rate of at least one layer among the layers in the second training epoch;
instructions for determining whether to freeze weight-updating on the at least one layer among the layers based on the sign flip rate of the at least one layer; and
instructions for updating a binary weight on a weight-updating unfrozen layer, in at least one training epoch performed subsequent to the second training epoch, the weight-updating unfrozen layer excludes at least one weight-updating frozen layer in which the weight-updating is frozen.
